(19) United States
(12) Patent Application Publication
(10) Pub. No.: US 2025/0022304 A1
(43) Pub. Date: Jan. 16, 2025

(54) SYSTEM AND METHOD FOR PROVIDING AUGMENTED REALITY-BASED COMPANION ANIMAL MANAGEMENT SERVICE, AND AUGMENTED REALITY DEVICE FOR THE SAME

(71) Applicant: LETINAR CO., LTD, Anyang-si (KR)

(72) Inventors: Min Ho YEO, Hwaseong-si (KR); Myung Rae KIM, Anyang-si (KR)

(73) Assignee: LETINAR CO., LTD, Anyang-si (KR)

(21) Appl. No.: 18/767,397

(22) Filed: Jul. 9, 2024

(30) Foreign Application Priority Data
Jul. 10, 2023 (KR) 10-2023-0089182

(51) Int. Cl. G06V 40/10; G02B 27/01

(52) U.S. Cl. CPC G06V 40/10; G02B 27/0172; G02B 2027/0138; G02B 2027/014; G02B 2027/0178

(57) ABSTRACT

The present invention provides a system for providing augmented reality-based companion animal management service, the system including: a state information generation unit configured to generate the state information of a nearby companion animal based on nearby image information transmitted from an augmented reality device of a user; a risk level determination unit configured to determine the risk level of the nearby companion animal based on the state information of the nearby companion animal and user information; and a notification information management unit configured to generate notification information according to the determined risk level and transmit the notification information to the augmented reality device; wherein the augmented reality device displays a notification image corresponding to the notification information as a virtual image together with a nearby image observed by the user, a method using the system, and an augmented reality device for the system and the method.

### CROSS-REFERENCE TO RELATED APPLICATION

This application claims the benefit of Korean Patent Application No. 10-2023-0089182 filed on Jul. 10, 2023, which is hereby incorporated by reference herein in its entirety.

### BACKGROUND

### 1. Technical Field

The present invention relates generally to a system for providing augmented reality-based companion animal management service, and more particularly to a system and method that display a notification image as a virtual image according to the risk level of a companion animal present in a nearby area while providing a nearby image to a user who wears an augmented reality device, and the augmented reality device for the same.

### 2. Description of the Related Art

Recently, the number of people raising companion animals such as dogs and cats has increased significantly, and many people walk around or exercise with their companion animals. Accidents such as dog bites often occur outdoors.

These accidents mainly occur when companion animals are not wearing muzzles or when users are careless even in the case where companion animals are wearing muzzles. When people can determine the risk levels of nearby companion animals in advance while walking with companion animals outdoors, they will be able to prevent such accidents.

Meanwhile, Augmented Reality (AR) refers to technology that provides users with virtual image information augmented from visual information in the real world by superimposing virtual images on real images of the real world and providing resulting images, as is well known.

Augmented reality is commonly implemented by a method of superimposing virtual images on real-world images and then providing resulting images while a user observes objects in the real world in the state of wearing an augmented reality device such as a head-mounted display (HMD) or smart glasses on his or her face.

Therefore, when other companion animals present in nearby areas and their risk levels are displayed in the nearby images observed by users via augmented reality devices, it is expected that various accidents such as dog bites can be prevented.

### SUMMARY

The present invention has been conceived to overcome the above-described problems, and an object of the present invention is to provide a system and method that display a notification image as a virtual image according to the risk level of a companion animal present in a nearby area while providing a nearby image to a user who wears an augmented reality device and also provide the augmented reality device for the same.

According to an aspect of the present invention, there is provided a system for providing augmented reality-based companion animal management service, the system including: a state information generation unit configured to generate the state information of a nearby companion animal based on nearby image information transmitted from an augmented reality device of a user; a risk level determination unit configured to determine the risk level of the nearby companion animal based on the state information of the nearby companion animal and user information; and a notification information management unit configured to generate notification information according to the determined risk level and transmit the notification information to the augmented reality device; wherein the augmented reality device displays a notification image corresponding to the notification information as a virtual image together with a nearby image observed by the user.

The nearby image information may include the nearby companion animal image information observed by the user, and the state information generation unit generates the state information of the nearby companion animal including at least any one of location information, type information, size information, information about whether a muzzle is worn, and companion information regarding the nearby companion animal.

The user information may include at least any one of user personal information and user companion animal information, and the user companion animal information may include at least any one of type information, size information, age information, and weight information regarding a companion animal.

The user information may be obtained from a database having previously stored user information based on the user identification information transmitted from the augmented reality device.

The risk level determination unit may determine the risk level by previously setting weights for respective pieces of information constituting the state information of the nearby companion animal and respective pieces of information constituting the user information and then calculating the sum of related weights.

The risk level determination unit may determine the risk level by using an artificial intelligence (AI)-based risk level determination model pre-trained on risk levels according to the state information of nearby companion animals and user information.

The notification information may include at least any one of text information, still image information, and moving image information.

The nearby image information may be repeatedly transmitted continuously or at regular intervals.

Each of the state information generation unit and the risk level determination unit may generate the state information of the nearby companion animal or determine the risk level of the nearby companion animal by additionally taking into consideration the location information of the augmented reality device.

Each of the state information generation unit and the risk level determination unit may generate the state information of the nearby companion animal or determine the risk level of the nearby companion animal by additionally taking into consideration the identification information of the nearby companion animal or the user information of the nearby companion animal.

The state information generation unit may generate the state information (hereinafter referred to as the “first state information”) of the nearby companion animal based on the nearby image information, and generate the state information (hereinafter referred to as the “second state information”) of the nearby companion animal based on the identification information of the nearby companion animal or user information of the nearby companion animal; the risk level determination unit may determine the risk level (hereinafter referred to as the “first risk”) of the nearby companion animal based on the first state information and the user information, and determine the risk level (hereinafter referred to as the “second risk level”) of the nearby companion animal based on the second state information and the user information; the system may further include a risk level decision unit configured to decide the risk level of the nearby companion animal based on the first and second risk levels transmitted from the risk level determination unit; and the notification information management unit may generate the notification information according to the risk level determined by the risk level determination unit.

The risk level decision unit may finally determine any one of the first and second risk levels to be the risk level of the nearby companion animal.

The risk level decision unit may finally determine the second risk level to be the risk level of the nearby companion animal when the first state information is not generated, may finally determine the first risk level to be the risk level of the nearby companion animal when the first state information is completely generated, and may finally determine a higher one of the first and second risk levels to be the risk level of the nearby companion animal when the first state information is incompletely generated.

The risk level decision unit may finally determine a higher one of the first and second risk levels to be the risk level of the nearby companion animal.

According to another aspect of the present invention, there is provided an augmented reality device for providing augmented reality-based companion animal management service in combination with a system for providing augmented reality-based companion animal management service, the augmented reality device including: an image output unit configured to output virtual image light corresponding to a virtual image; an augmented reality (AR) optical system configured to transfer the virtual image light, output from the image output unit, to a user's pupil while transferring nearby image light corresponding to an image of an area near the user to the user's pupil; a camera unit configured to acquire nearby image information by capturing an image of an area near the user, including an image of a nearby companion animal present near the user; a location information detection unit configured to detect the location information of the augmented reality device; and a control unit configured to transmit the nearby image information to the system for providing augmented reality-based companion animal management service; wherein the control unit receives notification information, generated according to a determined risk level, from the system for providing augmented reality-based companion animal management service, and displays a notification image corresponding to the notification information as a virtual image together with a nearby image observed by the user.

According to still another aspect of the present invention, there is provided a method of providing augmented reality-based companion animal management service in a system for providing augmented reality-based companion animal management service, the method including: a first step of receiving nearby image information from an augmented reality device; a second step of generating the state information of a nearby companion animal based on the nearby image information; a third step of determining the risk level of the nearby companion animal based on the state information of the nearby companion animal and user information; and a fourth step of generating notification information according to the determined risk level and transmitting the generated notification information to the augmented reality device; wherein the augmented reality device displays a notification image corresponding to the notification information as a virtual image together with a nearby image observed by a user.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the connection relationship between a system for providing augmented reality-based companion animal management service and an augmented reality device according to an embodiment of the present invention;

FIG. 2 is a block diagram functionally showing an example of the configuration of the augmented reality device;

FIG. 3 is a front view showing an example of the external shape of the augmented reality device that may be used in the present invention;

FIG. 4 is a diagram showing the configuration of the system;

FIG. 5 is a diagram illustrating an example of a method of determining a risk level based on the state information and user information of a nearby companion animal;

FIG. 6 is a flowchart illustrating an embodiment of a method of providing companion animal management service performed in the system described with reference to FIGS. 1 to 5;

FIGS. 7 to 10 are diagrams illustrating an example in which notification information is displayed as a virtual image according to the present invention; and

FIG. 11 is a diagram showing the configuration of a system according to another embodiment of the present invention.

### DETAILED DESCRIPTION

Embodiments of the present invention will be described in detail below with reference to the accompanying drawings.

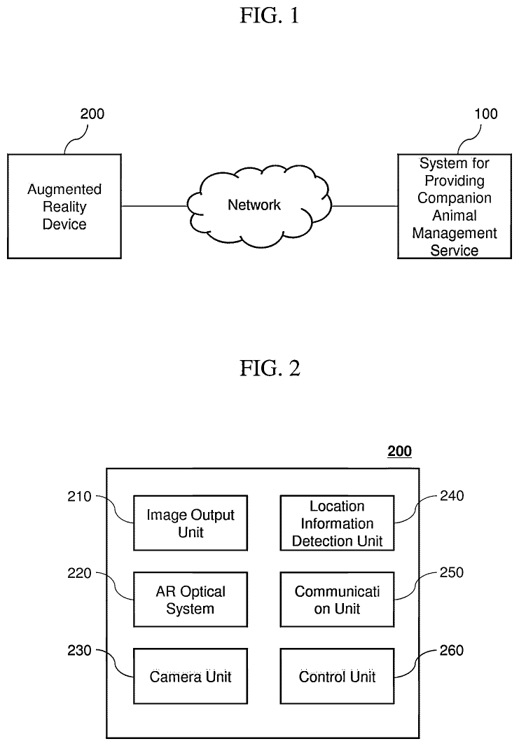

FIG. 1 is a diagram showing the connection relationship between a system 100 for providing augmented reality-based companion animal management service and an augmented reality device 200 according to an embodiment of the present invention.

Referring to FIG. 1, the system 100 for providing augmented reality-based companion animal management service (hereinafter briefly referred to as the “system 100”) is connected to the augmented reality device 200 over a network, and transmits and receives signals and information required for the practice of the present invention.

As will be described later, the system 100 functions to determine the risk level of a nearby companion animal near a user based on the nearby image information transmitted from the augmented reality device 200 of the user and transmit notification information to the augmented reality device 200 according to the determined risk level.

The augmented reality device 200 is a means for providing augmented reality (AR) by providing a virtual image together with an image of a real object to the user. In the present invention, the augmented reality device 200 functions to transmit nearby image information to the system 100 while displaying a nearby image, which is an image of a real object, and display a notification image as a virtual image in response to the notification information transmitted from the system 200.

Accordingly, in the case where the user wears the augmented reality device 200 and observes his or her surroundings, when a companion animal is present near the user, a notification image corresponding to notification information based on the risk level of the nearby companion animal may be provided to the user through the augmented reality device 200.

The augmented reality device 200 may be a conventionally known device such as a head-mounted display (HMD) or smart glasses that a user can wear on his or her face.

FIG. 2 is a block diagram functionally showing an example of the configuration of the augmented reality device 200.

Referring to FIG. 2, the augmented reality device 200 may include an image output unit 210, an AR (Augmented Reality) optical system 220, a camera unit 230, a location information detection unit 240, a communication unit 250, and a control unit 260.

The image output unit 210 is a means for outputting virtual image light, which is image light corresponding to a virtual image.

The image output unit 210 is a display device that displays a virtual image and outputs virtual image light corresponding to the displayed virtual image, and may be, for example, a small liquid crystal display (LCD), an organic light-emitting diode (OLED) display, a liquid crystal on-silicon (LCoS) display, or a micro-light-emitting diode (LED) display.

In this case, the virtual image is an image for augmented reality provided to the user, and may be a still image or a moving image.

In the present invention, the virtual image may be a notification image corresponding to the notification information transmitted from the system 100, as will be described later.

The AR optical system 220 functions to transmit the real object light output from a real object toward the user's pupil and, simultaneously, transmit virtual image light toward the user's pupil. That is, the AR optical system 220 functions as an optical combiner.

In the present invention, the AR optical system 220 functions to transmit nearby image light, corresponding to an image of an area near the user wearing the augmented reality device 200, to the user's pupil and, simultaneously, transmit virtual image light, corresponding to a virtual image output from the image output unit 210, to the user's pupil.

The camera unit 230 is a means for acquiring a nearby image observed by the user by capturing it.

In the present invention, the camera unit 230 functions to acquire nearby image information by capturing an image of the surroundings of the user and transmit it to the control unit 260.

In this case, the nearby image may include an image of a nearby companion animal present near the user, and the nearby image information may include information about the image of the nearby companion animal.

The location information detection unit 240 is a means for detecting information about the location of the augmented reality device 200.

For example, the location information detection unit 240 may be a device such as a conventionally known Global Positioning System (GPS) module. Alternatively, the location information detection unit 240 may be a device that can detect the location of the augmented reality device 200 by using information from a mobile communication network or the Internet.

The communication unit 250 is a means for connecting with the system 100 over a network and transmitting and receiving signals and information required for the present invention.

The communication unit 250 may be, for example, a device such as a Wi-Fi module or a device for communication with a mobile communication network such as an LTE module. Alternatively, the communication unit 250 may be one of other modules for short-distance communication.

The communication unit 250 transmits nearby image information to the system 100 in response to a control signal from the control unit 260, and receives notification information from the system 100 and transmits it to the control unit 260.

The camera unit 230, the location information detection unit 240, and the communication unit 250 themselves are not direct targets of the present invention and conventionally known technologies may be used for them without significant changes, so that detailed descriptions thereof will be omitted.

The control unit 260 functions to control and manage the overall operation of the augmented reality device 200.

In particular, in connection with the present invention, the control unit 260 functions to cause nearby image information to be transmitted to the system 100 and also cause a notification image corresponding to the notification information received from the system 100 to be displayed on the image output unit 210 as a virtual image.

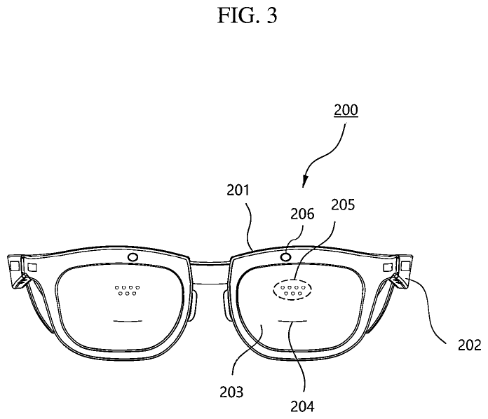

FIG. 3 is a front view showing an example of the external shape of the augmented reality device 200 that may be used in the present invention.

Referring to FIG. 3, the augmented reality device 200 is generally formed in the shape of smart glasses having the conventionally known shape of glasses. The augmented reality device 200 may include a frame part 201, fixation parts 202, lenses 203, first reflective units 204, and second reflective units 205.

The frame part 201 is a means for fixing the lenses 203. As shown in the drawing, the frame part 201 may be formed to entirely surround the outer circumferential surfaces of the lenses 203.

The fixation parts 202 are means for being coupled with the frame part 201 and fixing the augmented reality device 200 so that it can be worn on a user's face. As shown in the drawing, the fixation parts 202 may be formed in the shape of temples that can be worn on the user's ears.

The lenses 203 may be made of transparent resin or glass, and a corresponding one of the first reflective units 204 and a corresponding one of the second reflective units 205 may be embedded in each of the lenses 203.

The first reflective units 204 functions to transfer the virtual image light, output from the image output unit 210, to a corresponding one of the second reflective units 205.

The first reflective unit 204 is a means for converting incident virtual image light according to preset conditions, such as an optical path and a focal length, and then outputting resulting virtual image light. For example, the first reflective unit 204 may be a reflective element that functions as a collimator that converts incident light into parallel light and outputs the parallel light.

As an embodiment, the virtual image light output from the first reflective unit 204 may be transferred to the second reflective unit 205 through total internal reflection (TIR) inside a corresponding one of the lenses 203.

The second reflective unit 205 functions to provide a virtual image to the user by transferring virtual image light to the user's pupil.

The second reflective unit 205 may be a reflective element that transfers the incident virtual image light, transferred from the first reflective unit 204, to the pupil by reflecting it.

The second reflective unit 205 is configured such that the elements thereof may be arranged at intervals to appear as a two-dimensional array, as shown in the drawing. Real object light may be transferred to the user's pupil through the spaces provided by these intervals. Accordingly, the second reflective unit 205 may provide a see-through function, by which augmented reality (AR) in which a virtual image is superimposed on a real object image may be provided to the user.

The lenses 203, the first reflective unit 204, and the second reflective unit 205 constitute the AR optical system 220 described above.

Meanwhile, the image output unit 210, camera unit 230, location information detection unit 240, communication unit 250, and control unit 260 described with reference to FIG. 2 may be disposed inside the frame unit 201.

Furthermore, a camera lens unit 206 configured to transfer light to the camera unit 230 may be disposed on the outside of the frame unit 201.

Furthermore, cables configured to connect the above-described components may be disposed inside the frame part 201.

Meanwhile, the augmented reality device 200 described with reference to FIGS. 2 and 3 is illustrative, and the present invention is not limited to this augmented reality device 200. In other words, it should be noted that any type of device may be used as the augmented reality device 200 in the present invention regardless of the specific form or arrangement thereof as long as it is an augmented reality provision device that provides virtual image light together with real object light to a user.

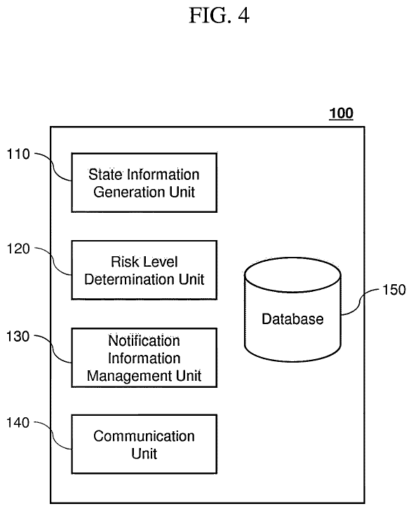

FIG. 4 is a diagram showing the configuration of the system 100.

Referring to FIG. 4, the system 100 includes a state information generation unit 110, a risk level determination unit 120, a notification information management unit 130, a communication unit 140, and a database 150.

The state information generation unit 110 functions to generate the state information of a nearby companion animal present near a user based on the nearby image information transmitted from the augmented reality device 200.

In this case, as described above, the nearby image information may include the image information of another companion animal present near the user, i.e., nearby companion animal image information.

The state information generation unit 110 first determines whether the nearby image information includes nearby companion animal image information. For example, this may be performed by a method of determining whether a companion animal is included in a nearby image corresponding to the nearby image information by using an artificial intelligence (AI)-based image analysis model (not shown) pre-trained on images of companion animals.

When nearby companion animal image information is included in the nearby image information, the state information generation unit 110 generates the state information of a corresponding nearby companion animal.

In this case, the state information is information indicating the state of the nearby companion animal. For example, the state information may include at least any one of pieces of information such as location information, type information, size information, information about whether a muzzle is worn, and companion information regarding the nearby companion animal.

In this case, the location information may be latitude/longitude information indicating the distance between the augmented reality device 200 and the nearby companion animal or the location where the nearby companion animal is present.

The type information may be information about the breed of the nearby companion animal, such as a shepherd, a Jindo dog, a Chihuahua, a bulldog, or the like.

The type information may be identified and stored according to the type as which the companion animal was previously classified, and may be used for the determination of a risk level, which will be described later, because the tendency, such as aggression, of the corresponding companion animal can be determined.

The size information is information indicating the actual size of the nearby companion animal, and the information about whether a muzzle is worn is information indicating whether the nearby companion animal is wearing a muzzle.

The companion information is information indicating whether the nearby companion animal is present alone or is accompanied by a guardian.

These pieces of state information may obtained by a method of determining the state information of the companion animal also by using an AI-based image analysis model (not shown).

When the state information is generated, the state information generation unit 110 transfers the state information to the risk level determination unit 120.

The risk level determination unit 120 functions to determine the risk level of the nearby companion animal based on the state information of the nearby companion animal generated by the state information generation unit 110 and the user information previously stored.

In this case, the risk level is information indicating the degree to which the nearby companion animal is risky to the user or the user's companion animal.

The user information may include at least any one of user personal information and user companion animal information.

The user personal information may include at least any one of pieces of information about the user, such as the gender, age, height, weight, and disease of the user, and the like.

Furthermore, the user companion animal information may include at least any one of pieces of information such as the type, size, age, and weight of the companion animal kept by the user and the like.

This user information is previously stored in the database 140. When the augmented reality device 200 transmits nearby image information to the system 100, the identification information of the augmented reality device 200 or user may also be transmitted, and the system 100 may determine the user information based on the identification information.

The risk level determination unit 120 may individually determine the risk level of the nearby companion animal by comprehensively taking into consideration the state information of the nearby companion animal generated by the state information generation unit 110 and the user information described above.

For example, in the case where the size of the user's companion animal is the size of a small dog such as a Chihuahua, when the size of the nearby companion animal is 1 m or more based on the state information, the risk level may be determined to be high.

Furthermore, even in the case where the size of the nearby companion animal is small, when the type of nearby companion animal is determined to be a vicious dog such as a pit bull terrier based on the state information, the risk level may be determined to be significantly high.

Moreover, when it is determined that the nearby companion animal is not wearing a muzzle, the risk level may be determined to be high, but the risk level may be calculated by comprehensively taking into consideration information such as the size and type of the nearby companion animal, whether the nearby companion animal has a guardian, and/or the like.

Meanwhile, the risk level may be determined to be one of a plurality of levels.

As an example, the risk level may be determined to be one of three levels, such as “significantly risky,” “cautious,” and “safe.” As another example, the risk level may be determined to be one of five levels, such as “significantly risky,” “risky,” “cautious,” “safe,” and “significantly safe.”

The risk level may be determined by a method of previously setting weights for respective types of information constituting the state information of the nearby companion animal and respective types of information constituting the user information as described above, calculating the sum of related weights, and determining the risk level based on the results of the calculation.

Another method for determining the risk level is to automatically determine the risk level by preparing an AI-based risk level determination model, pre-training the AI-based risk level determination model on various risk levels according to the state information of nearby companion animals and user information, and entering the state information of a target nearby companion animal and target user information.

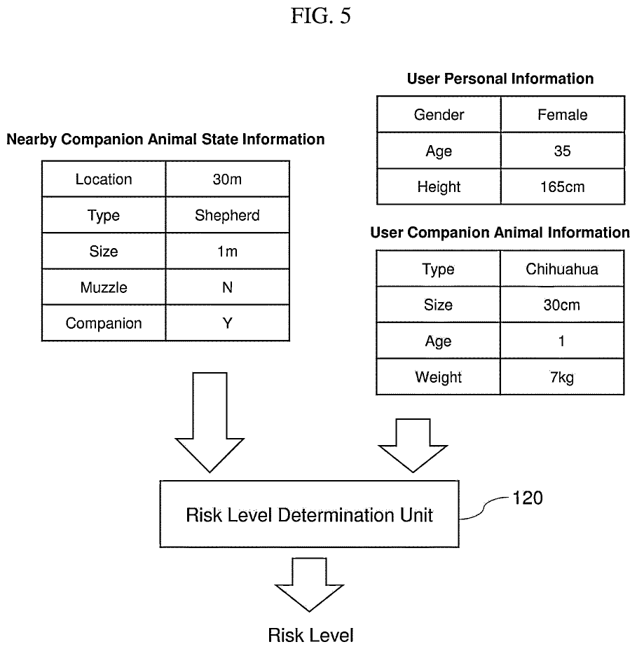

FIG. 5 is a diagram illustrating an example of a method of determining a risk level based on the state information of a nearby companion animal and user information.

As shown in the drawing, the state information of a nearby companion animal includes location information, type information, size information, information about whether a muzzle is worn, and companion information.

The user information includes user personal information and user companion animal information. The user personal information includes gender information, age information, and height information. The user companion animal information includes type information, size information, age information, and weight information.

The risk level determination unit 120 may determine the risk level in the same manner as described above based on the state information of the nearby companion animal and user information.

The notification information management unit 130 functions to generate notification information according to the risk level determined by the risk level determination unit 120 and transmit the generated notification information to the augmented reality device 200.

This notification information is information corresponding to a notification image to be displayed as a virtual image in the augmented reality device 200, and may include at least any one of text information, still image information, and moving image information.

This depends on the form in which the notification image will be displayed.

For example, the notification information may include text information used to display the above-described risk level as text and image information used to display a corresponding color as a virtual image after the preset color corresponding to the above-described risk level has been set.

Furthermore, the notification information may be image information representing an identification mark or indication corresponding to the risk level.

The communication unit 140 is a means for connecting with the augmented reality device 200 over a network transmitting and receiving signals and information required for the present invention.

The communication unit 140 functions to transfer the nearby image information, transferred from the augmented reality device 200, to the state information generation unit 110 and transfer the notification information, generated by the notification information management unit 130, to the augmented reality device 200.

The communication unit 130 may also be a Wi-Fi module, an LTE module, or one of other modules for short-distance communication.

The database 150 is a means for storing information required for the practice of the present invention.

The database 150 may store the state information of nearby companion animals and user information as described above.

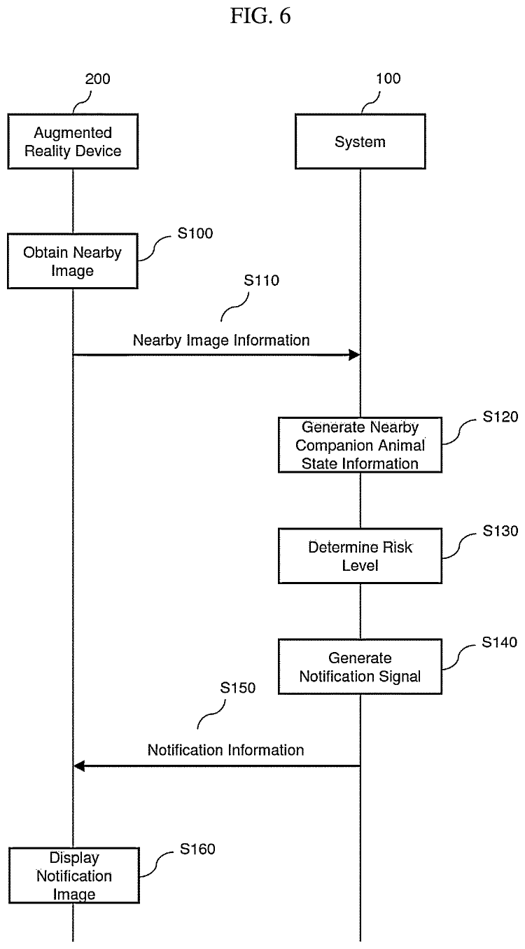

FIG. 6 is a flowchart illustrating an embodiment of a method of providing companion animal management service performed in the system 100 described with reference to FIGS. 1 to 5.

Referring to FIG. 6, first, the augmented reality device 200 acquires a nearby image by capturing it and transfers nearby image information to the system 100 in steps S100 and S110.

The state information generation unit 110 of the system 100 that has received the nearby image information generates the state information of a nearby companion animal based on the nearby image information, as described above, in step S120.

When the state information of the nearby companion animal is generated, the risk level determination unit 120 of the system 100 determines the risk level of the nearby companion animal based on the state information of the nearby companion animal and user information, as described above, in step S130.

Then, the notification information management unit 130 of the system 100 generates notification information according to the risk level determined as described above and transmits the generated notification information to the augmented reality device 200 in steps S140 and S150.

The control unit 260 of the augmented reality device 200 that has received the notification information from the system 100 causes a notification image corresponding to the received notification information to be displayed as a virtual image on the image output unit 210 in step S160.

As a result, the notification image corresponding to the risk level of the nearby companion animal is provided to a user as a virtual image through the augmented reality device 200, so that the user can perceive the risk level of the nearby companion animal through the augmented reality device 200 while observing surroundings.

Meanwhile, in the above-described embodiment, steps S100 to S160 may repeatedly be performed continuously or at regular intervals.

In this case, when the nearby companion animal gradually becomes closer, the magnitude of the distance information included in the nearby animal state information decreases. It may be possible to generate notification information differently by taking the above fact into consideration and then transmit the different notification information. For example, as the distance becomes shorter, the risk level may be determined to be higher and displayed in a different color.

Furthermore, when the nearby companion animal gradually moves away from the user, the risk level may gradually be changed to a lower level and displayed in a different color.

Furthermore, the notification image may be displayed near the area where the nearby companion animal is located in the nearby image observed by the user.

Furthermore, the notification image may be displayed together with an electronic map. For example, it may be possible to display an electronic map corresponding to the nearby image observed by the user and also display the notification image on the electronic map while displaying the location of the nearby companion animal on the electronic map.

Furthermore, the notification information may further include auditory information corresponding to an auditory signal that provides an appropriate guidance message according to the risk level, and/or tactile information that causes the augmented reality device 200 to vibrate according to the risk level. In this case, the augmented reality device 200 may output an auditory signal corresponding to the risk level and cause the augmented reality device 200 to vibrate while displaying the notification image.

For example, when the color of a nearby companion animal whose risk level is significantly high is displayed in red, the blinking speed of the color may gradually increase as the nearby companion animal becomes closer.

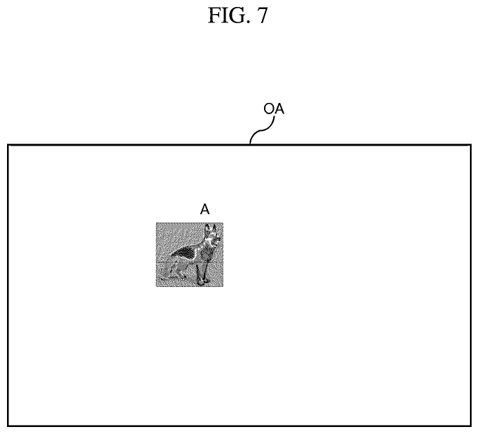

FIGS. 7 to 10 are diagrams illustrating an example in which notification information is displayed as a virtual image according to the present invention.

FIG. 7 shows a user's field of view screen OA while the user is wearing the augmented reality device 200, which shows a state in which a nearby companion animal A is being observed on the field of view screen OA.

In this state, as described above, the augmented reality device 200 transmits nearby image information to the system 100, the system 100 transmits notification information to the augmented reality device 200 through the process described above, and the augmented reality device 200 displays a notification image corresponding to the notification information as a virtual image on the image output unit 210.

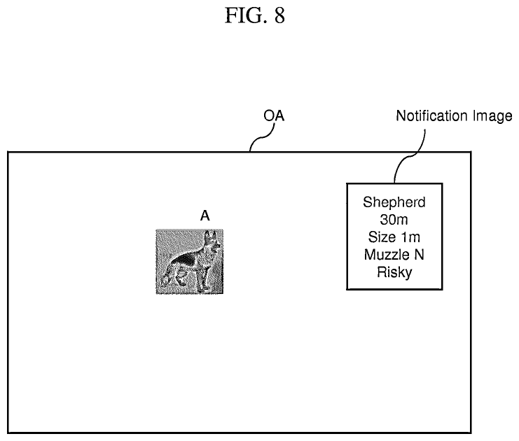

FIG. 8 shows an example of a user's field of view screen OA with a notification image displayed thereon.

That is, in the state shown in FIG. 7, when notification information is transmitted from the system 100, the augmented reality device 200 causes a notification image corresponding to the notification information to be displayed as a virtual image in the upper right corner of the user's field of view OA.

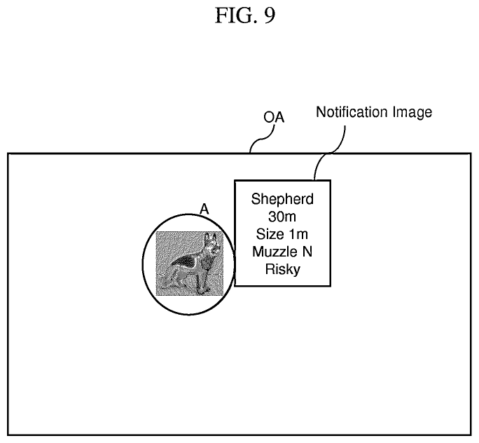

FIG. 9 shows another example of displaying a notification image.

As shown in this drawing, it can be seen that the notification image is displayed near the nearby companion animal A. In this case, for example, a circle in red color may be displayed around the area of the nearby companion animal A to emphasize the nearby companion animal A.

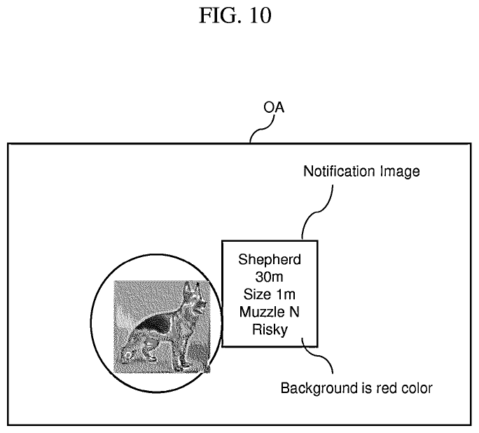

FIG. 10 shows another example of displaying a notification image.

FIG. 10 shows a case where the nearby companion animal A moves closer to the user in the state shown in FIG. 9. In this drawing, the location of the nearby companion animal A has changed on the user's field of view screen OA, and the location of the notification image has also changed correspondingly.

Furthermore, it can be seen that the distance information changes from 30 m to 10 m in the notification image and the background of the notification image is displayed in, for example, red color.

Meanwhile, in the above-described embodiment, the system 100 has been described as generating state information and determining the risk level based on the nearby image information received from the augmented reality device 200. However, it may be possible to receive the location information of the augmented reality device 200 together with nearby image information from the augmented reality device 200 and generate state information or determine the risk level based on the received information.

In this case, the location information of the augmented reality device 200 may be used to calculate the location information of nearby companion animal state information or to display the location of a nearby companion animal on an electronic map, as described above.

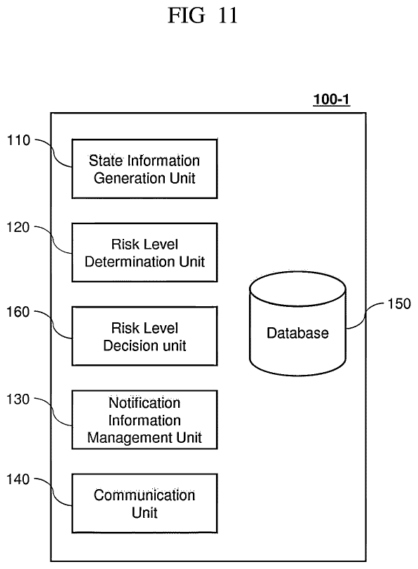

FIG. 11 is a diagram showing the configuration of a system 100-1 according to another embodiment of the present invention.

The system 100-1 of the embodiment of FIG. 11 is the same as the system 100 described with reference to FIGS. 1 to 10, except that state information is generated and also the risk level is determined by additionally taking into consideration not only nearby image information but also the identification information of a nearby companion animal or the user information of a nearby companion animal.

To this end, the system 100-1 may further include a risk level decision unit 160, and each of a state information generation unit 110 and a risk level determination unit 120 operates as follows.

As described above, the state information generation unit 110 generates the state information (hereinafter referred to as the “first state information”) of a nearby companion animal present near a user based on the nearby image information transmitted from the augmented reality device 200, and generates the state information (hereinafter referred to as the “second state information”) of the nearby companion animal based on the identification information of the nearby companion animal or user information of the nearby companion animal. Furthermore, the state information generation unit 110 transmits the first state information and the second state information to the risk level determination unit 120.

The risk determination unit 120 determines the risk level (hereinafter referred to as the “first risk level”) of the nearby companion animal based on the first state information and the user information as described above, and determines the risk level (hereinafter referred to as the “second risk level”) of the nearby companion animal based on the second state information and the user information. Furthermore, the risk determination unit 120 transfers the determined first and second risk levels to the risk level decision unit 160.

The risk level decision unit 160 functions to decide the risk level of the nearby companion animal based on the first and second risk levels transferred from the risk level determination unit 120.

Furthermore, the notification information management unit 130 generates notification information according to the risk level decided by the risk level decision unit 160 as described above and transmits the notification information to the augmented reality device 200.

In this case, the identification information of the nearby companion animal and the user information of the nearby companion animal may include information such as the information shown in FIG. 5. This information may be obtained from the user information transmitted from the augmented reality device 200 when the guardian of the nearby companion animal wears the augmented reality device 200 described above.

Furthermore, the nearby animal state information such as the information shown in FIG. 5 may be previously stored in the database 150 of the system 100-1 according to the identification information or user information of the nearby companion animal.

Furthermore, the identification information or user information of the nearby companion animal may be stored in, for example, a necklace-type device having a communication function, the nearby companion animal may be allowed to wear the necklace-type device, and the identification information or user information of the nearby companion animal may be caused to be periodically transmitted to the system 100-1.

The state information generation unit 110 of the system 100-1 may obtain nearby companion animal state information (second state information) from the database 150 based on the transmitted identification information or user information of the nearby companion animal. The risk level determination unit 120 may determine the second risk level based on the second state information and the user information.

In this case, the second and first risk levels based on the nearby image information obtained as described in the above-described embodiment may be different from each other.

In this case, the risk level decision unit 160 may finally determine any one of the first and second risk levels to be the risk level of the nearby companion animal.

This may be determined, for example, by the following method.

First, when the nearby companion animal is not clearly identified by the nearby image information, the second risk level is finally determined to be the risk level of the nearby companion animal. This may occur when the nearby companion animal is not present in the nearby image information or is present but is not clearly distinguished such that the first state information cannot be generated.

Furthermore, when the nearby companion animal is clearly identified by the nearby image information, the first risk level may be finally determined to be the risk level of the nearby companion animal. This corresponds to a case where the first state information is completely generated by the nearby image information.

Meanwhile, when a nearby companion animal appears to be present based on nearby image information but is not clearly identified, the higher one of the first and second risk levels may be finally determined to be the risk level of the nearby companion animal. This may occur when the first state information is incompletely generated by the nearby image information.

Further, in addition to the method described above, the higher one of the first and second risk levels may be finally determined to be the risk level of the nearby companion animal.

Meanwhile, in the above-described embodiment, although the state information generation unit 110 has been described as generating the first state information and the second state information, this is merely an example. Part of the nearby companion animal state information may be generated based on the nearby image information, and the rest thereof may be generated based on the identification information or user information of the nearby companion animal.

For example, in the state information of the nearby companion animal, the information stored in the database 150 may be first used as type information, and the information determined through nearby image information may be first used as size information.

According to the present invention, there are provided the system and method that display a notification image as a virtual image according to the risk level of a companion animal present in a nearby area while providing a nearby image to a user who wears the augmented reality device, and there is also provided the augmented reality device for the same.

Although the embodiments of the present invention have been described above, the present invention is not limited to the above-described embodiments, and various modifications and alterations may be made within the scope of the present invention determined by the attached claims and the accompanying drawings.

What is claimed is:

1. A system for providing augmented reality-based companion animal management service, the system comprising:
a state information generation unit configured to generate state information of a nearby companion animal based on nearby image information transmitted from an augmented reality device of a user;
a risk level determination unit configured to determine a risk level of the nearby companion animal based on the state information of the nearby companion animal and user information; and
a notification information management unit configured to generate notification information according to the determined risk level and transmit the notification information to the augmented reality device;
wherein the augmented reality device displays a notification image corresponding to the notification information as a virtual image together with a nearby image observed by the user.

2. The system of claim 1, wherein:
the nearby image information includes nearby companion animal image information observed by the user; and
the state information generation unit generates the state information of the nearby companion animal including at least any one of location information, type information, size information, information about whether a muzzle is worn, and companion information regarding the nearby companion animal.

3. The system of claim 1, wherein:
the user information includes at least any one of user personal information and user companion animal information; and
the user companion animal information includes at least any one of type information, size information, age information, and weight information regarding a companion animal.

4. The system of claim 1, wherein the user information is obtained from a database having previously stored user information based on user identification information transmitted from the augmented reality device.

5. The system of claim 1, wherein the risk level determination unit determines the risk level by previously setting weights for respective pieces of information constituting the state information of the nearby companion animal and respective pieces of information constituting the user information and then calculating a sum of related weights.

6. The system of claim 1, wherein the risk level determination unit determines the risk level by using an artificial intelligence (AI)-based risk level determination model pre-trained on risk levels according to state information of nearby companion animals and user information.

7. The system of claim 1, wherein the notification information includes at least any one of text information, still image information, and moving image information.

8. The system of claim 1, wherein the nearby image information is repeatedly transmitted continuously or at regular intervals.

9. The system of claim 1, wherein each of the state information generation unit and the risk level determination unit generates the state information of the nearby companion animal or determines the risk level of the nearby companion animal by additionally taking into consideration location information of the augmented reality device.

10. The system of claim 1, wherein each of the state information generation unit and the risk level determination unit generates the state information of the nearby companion animal or determines the risk level of the nearby companion animal by additionally taking into consideration identification information of the nearby companion animal or user information of the nearby companion animal.

11. The system of claim 1, wherein:
the state information generation unit generates state information (hereinafter referred to as “first state information”) of the nearby companion animal based on the nearby image information, and generates state information (hereinafter referred to as “second state information”) of the nearby companion animal based on identification information of the nearby companion animal or user information of the nearby companion animal;
the risk level determination unit determines a risk level (hereinafter referred to as a “first risk”) of the nearby companion animal based on the first state information and the user information, and determines a risk level (hereinafter referred to as a “second risk level”) of the nearby companion animal based on the second state information and the user information;
the system further comprises a risk level decision unit configured to decide the risk level of the nearby companion animal based on the first and second risk levels transmitted from the risk level determination unit; and
the notification information management unit generates the notification information according to the risk level determined by the risk level determination unit.

12. The system of claim 11, wherein the risk level decision unit finally determines any one of the first and second risk levels to be the risk level of the nearby companion animal.

13. The system of claim 12, wherein the risk level decision unit:
finally determines the second risk level to be the risk level of the nearby companion animal when the first state information is not generated;
finally determines the first risk level to be the risk level of the nearby companion animal when the first state information is completely generated; and
finally determines a higher one of the first and second risk levels to be the risk level of the nearby companion animal when the first state information is incompletely generated.

14. The system of claim 12, wherein the risk level decision unit finally determines a higher one of the first and second risk levels to be the risk level of the nearby companion animal.

15. An augmented reality device for providing augmented reality-based companion animal management service in combination with a system for providing augmented reality-based companion animal management service, the augmented reality device comprising:
an image output unit configured to output virtual image light corresponding to a virtual image;
an augmented reality (AR) optical system configured to transfer the virtual image light, output from the image output unit, to a user's pupil while transferring nearby image light corresponding to an image of an area near the user to the user's pupil;
a camera unit configured to acquire nearby image information by capturing an image of an area near the user, including an image of a nearby companion animal present near the user;
a location information detection unit configured to detect location information of the augmented reality device; and
a control unit configured to transmit the nearby image information to the system for providing augmented reality-based companion animal management service;
wherein the control unit receives notification information, generated according to a determined risk level, from the system for providing augmented reality-based companion animal management service, and displays a notification image corresponding to the notification information as a virtual image together with a nearby image observed by the user.

16. A method of providing augmented reality-based companion animal management service in a system for providing augmented reality-based companion animal management service, the method comprising:
a first step of receiving nearby image information from an augmented reality device;
a second step of generating state information of a nearby companion animal based on the nearby image information;
a third step of determining a risk level of the nearby companion animal based on the state information of the nearby companion animal and user information; and
a fourth step of generating notification information according to the determined risk level and transmitting the generated notification information to the augmented reality device;
wherein the augmented reality device displays a notification image corresponding to the notification information as a virtual image together with a nearby image observed by a user.
